(19) United States
(12) Patent Application Publication
(10) Pub. No.: US 2006/0226644 A1
(43) Pub. Date: Oct. 12, 2006

(54) Gas bag module with a discharge arrangement

(75) Inventor: Matthias Helmstetter, Aschaffenburg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive Safety Systems GmbH

(21) Appl. No.: 11/397,453

(22) Filed: Apr. 4, 2006

(30) Foreign Application Priority Data
Apr. 12, 2005 (DE) 20 2005 005 797.5

(51) Int. Cl. B60R 21/239

(52) U.S. Cl. 280/739

(57) ABSTRACT

A gas bag module for a vehicle occupant restraint system includes a gas bag (12) and a discharge arrangement (18). The discharge arrangement (18) has a unit able to be activated (26) by a control arrangement (19) for selectively providing a discharge opening. The unit able to be activated (26) is arranged on a mounting (24) which performs a hinge function upon activation of the unit (26).

### TECHNICAL FIELD

The invention relates to a gas bag module for a vehicle occupant restraint system, in particular to a gas bag module including a gas bag and a discharge arrangement.

### BACKGROUND OF THE INVENTION

Discharge openings allow the internal pressure of the gas bag to be reduced, which is efficient in particular cases of restraint. Numerous possibilities have become known in the meantime for influencing the internal pressure and hence the restraining effect of the gas bag through the selective exposure of a discharge opening.

A gas bag module in which a discharge region can be opened in the gas bag wall, is known from international patent application WO-A-2004/045919. The gas bag module includes a gas bag and a discharge arrangement which has a unit able to be activated by means of a control arrangement for selectively providing a discharge opening. A pyrotechnic charge in the form of a fuse is arranged directly on the discharge region of the gas bag wall such that the discharge region burns through or is torn open mechanically after the fuse is ignited.

Fuses to produce discharge openings are also used in the gas bag module known from British patent application GB-A-2329364. Here, particular regions of a reaction vessel, a manifold or a gas generator are burned through.

In the gas bag module shown in British patent application GB-A-2306409 a discharge opening of the gas bag is closed by a plate. A pyrotechnic charge arranged on the plate burns through a weakened section of the plate such that a flap is formed. The flap can open by the internal pressure of the gas bag and can expose the discharge opening.

It is an object of the invention to provide a gas bag module which renders a specific exposure of a discharge opening possible in a reliable manner.

### BRIEF DESCRIPTION OF THE INVENTION

According to the invention, a gas bag module for a vehicle occupant restraint system includes a gas bag and a discharge arrangement. The discharge arrangement has a unit able to be activated by a control arrangement for selectively providing a discharge opening. The unit able to be activated is arranged on a mounting which performs a hinge function upon activation of the unit. On the one hand, the mounting provides for a secure positioning of the unit which is able to be activated and, on the other hand, enables a folding away to take place, so as to thus expose the discharge opening and so as not to obstruct the outflowing gas. The mounting also gives the direction and the region in which the unit able to be activated takes its effect.

A preferred construction for the discharge arrangement makes provision that the mounting has a hinge region and a swivel section on which the unit able to be activated is fastened. The hinge region allows the swivel section to be folded away with the unit able to be activated, such that after the discharge opening has been provided, an unimpeded discharge of the gas is ensured.

The discharge arrangement can be arranged on a rigid component of the gas bag module. Preferably, however, the discharge arrangement is arranged on a wall of the gas bag.

According to a further development of the invention, particular regions of the gas bag fabric adjoining the discharge arrangement are weakened.

The weakened regions are preferably coordinated with the unit able to be activated such that upon activation of the unit, the gas bag fabric tears open in the weakened regions. The weakened regions therefore substantially define the shape and size of the discharge opening.

In a construction of the discharge arrangement with a hinge region and a swivel section, it is expedient to provide the weakened regions only on one side of the hinge region, namely on the side of the swivel section.

According to a preferred embodiment of the invention, the weakened regions are formed by outlet openings. Passive outlet openings are therefore also available alongside the discharge opening which is able to be actively controlled. With such a combination, a decision can be made as a function of suitable parameters, as to whether it is efficient to expose the discharge opening in addition to the passive outlet openings.

The design of the outlet openings such that the effective cross-section of the outlet openings is increased as the internal pressure of the gas bag increases, is particularly advantageous. The passive outlet openings then automatically adapt themselves to the intensity of the impact, which depends above all on the size and weight of the vehicle occupant. Under particular circumstances, such as for instance at high speed or when the vehicle occupant is a short distance from the gas bag, the discharge opening can be additionally exposed, in order to make it possible to quickly decrease the internal pressure of the gas bag.

The integration into the gas bag fabric of the electrical leads by which the discharge arrangement is connected with the control arrangement has the advantage that the leads are protected before and during the unfolding of the gas bag. For this, the leads can for example be glued, welded, sewn or woven in between two fabric layers.

A pyrotechnic unit with an explosive charge is recommended as the unit able to be activated. Such units have proven to be successful in a variety of applications.

Alternatively, the unit able to be activated may also have an electrorheological fluid.

### BRIEF DESCRIPTION OF THE DRAWINGS

FIG. 1 shows a gas bag module according to the invention with an unfolded gas bag in a case of stress;

FIG. 2 shows an external view of a cut-out of the gas bag wall;

FIG. 3 shows an internal view of the cut-out of FIG. 2;

FIG. 4 shows a perspective sectional view along the line IV-IV in FIG. 2;

FIG. 5 shows a perspective sectional view along the line V-V in FIG. 3;

FIG. 6 shows a view corresponding to FIG. 2 with alternatively constructed passive outlet openings;

FIG. 7 shows an alternative embodiment of the discharge arrangement in a view corresponding to FIG. 3;

FIG. 8 shows a top view of a discharge arrangement according to a further embodiment of the invention;

FIG. 9 shows a bottom view of the discharge arrangement of FIG. 8;

FIG. 10 shows a perspective sectional view along the line X-X in FIG. 8; and

FIG. 11 shows a perspective sectional view along the line XI-XI in FIG. 9.

### DETAILED DESCRIPTION OF THE PREFERRED EMBODIMENTS

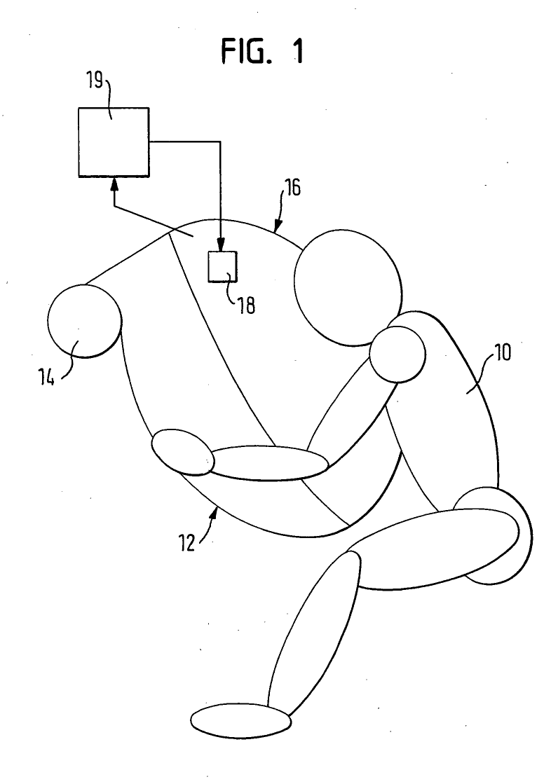

In FIG. 1 a vehicle occupant 10 is illustrated, plunging into an inflated gas bag 12 of a vehicle occupant restraint system. The gas bag 12, which has unfolded from the housing of a gas bag module 14, has a gas bag wall 16 on which a discharge arrangement 18 is arranged which is able to be controlled electrically by means of a control arrangement 19. The discharge arrangement 18 serves to selectively provide a discharge opening through which gas can escape from the gas bag 12.

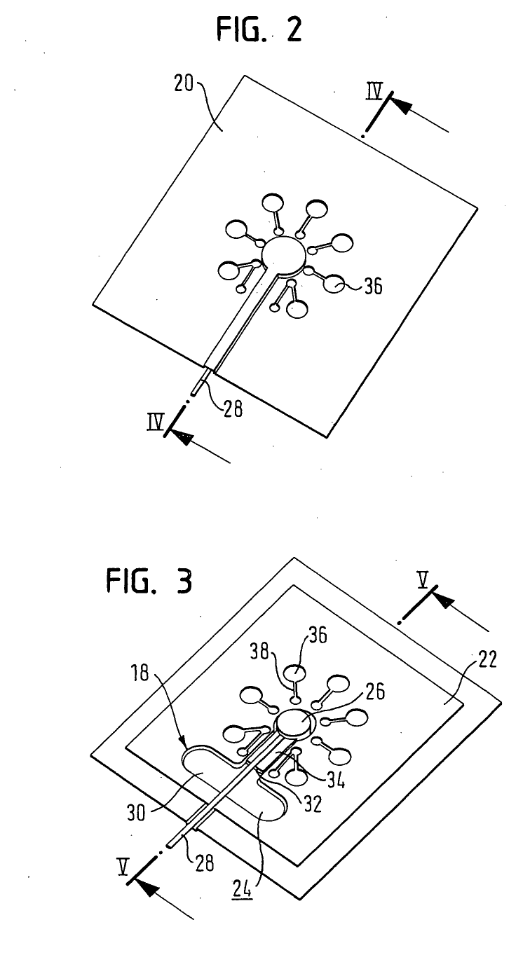

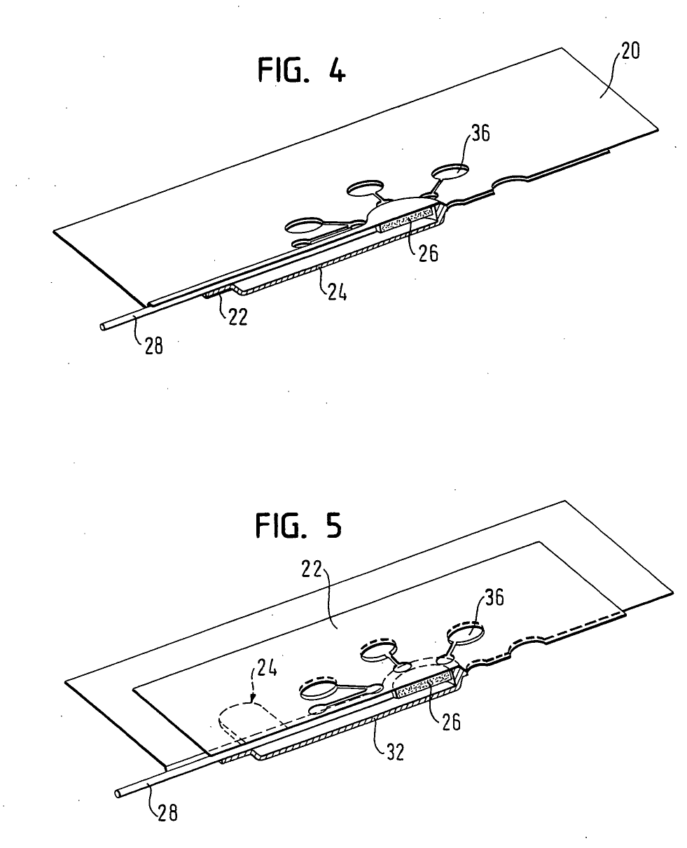

A first embodiment of the invention is illustrated in FIGS. 2 to 5. The wall of the gas bag 12 has an outer fabric layer 20 and an inner fabric layer 22. The discharge arrangement 18 is arranged at a suitable site on the gas bag wall between the two fabric layers 20, 22. The discharge arrangement 18 has substantially a mounting 24 a unit able to be activated in the form of a pyrotechnic charge 26 with an igniter (squib), and electric leads 28 which connect the discharge arrangement 18 with the control arrangement 19. The discharge arrangement 18 can be fastened by glueing, pressing, welding, sewing in, weaving in or the like. The electric leads 28 are protected at all times as they are integrated into the gas bag fabric.

The mounting 24 consists substantially of a metal or plastic plate which has an elongated section 30, a hinge region 32 in the form of a film hinge, and a swivel section 32. The pyrotechnic charge 26 is fastened on the side of the swivel section 34 facing the interior of the gas bag.

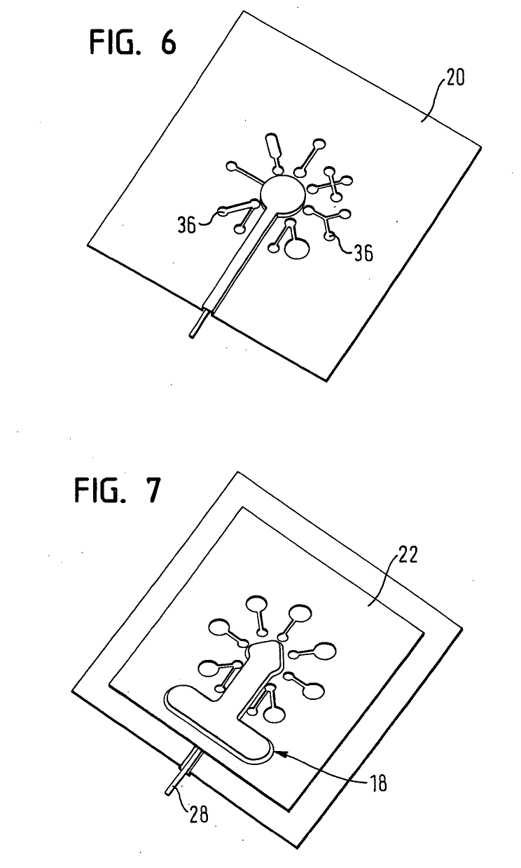

Particular regions of the gas bag fabric adjoining the discharge arrangement 18 are weakened. In the illustrated embodiment, the weakened regions are constructed as passive outlet openings 36. The outlet openings 36 are arranged around the swivel section 34 of the mounting 24 and are partially connected with each other by slits 38, such that the effective outlet cross-section of the outlet openings 36 is variable. The outlet openings 36 or their effective outlet cross-sections may, however, also be constructed differently from the illustrations of FIGS. 2 and 3. Some examples of alternative geometries are shown in FIG. 6.

In a case of restraint, the gas bag 12 is inflated in a known manner. In the case of a high-intensity impact, the discharge arrangement 18 is not activated. In this case, the passive outlet openings 36 alone determine the pressure in the interior of the gas bag 12 and hence the restraining effect. The passive outlet openings 36 may be designated as dynamic openings because their effective outlet cross-section increases with a higher internal pressure. This occurs in that the sections of the gas bag fabric adjoining the slits 38 fold open more intensively such that more gas can emerge.

As mentioned in the introduction, it is, however, efficient in particular situations to reduce the internal pressure of the gas bag as quickly as possible. The control arrangement 19 then activates the discharge arrangement 18 by the pyrotechnic charge 26 being ignited. The weakened regions of the gas bag fabric are coordinated with the pyrotechnic charge 26 in their arrangement and dimensioning such that through the explosion, the gas bag fabric tears open in these regions. The arrangement of the pyrotechnic charge 26 on the side facing the interior of the gas bag makes provision that the swivel section 34 of the mounting 24 folds away outwards about an axis provided by the hinge region 32. The folding away outwards is assisted in addition by the internal pressure of the gas bag. A discharge opening with a large cross-section is therefore available, through which a large quantity of gas can escape in a short period of time.

FIG. 7 shows a second embodiment of the invention. The discharge arrangement 18 has an electrorheological fluid instead of the pyrotechnic charge and the igniter. By applying an electric voltage to the fluid, the latter changes its characteristics within a few milliseconds. This change can be utilized to provide the discharge opening.

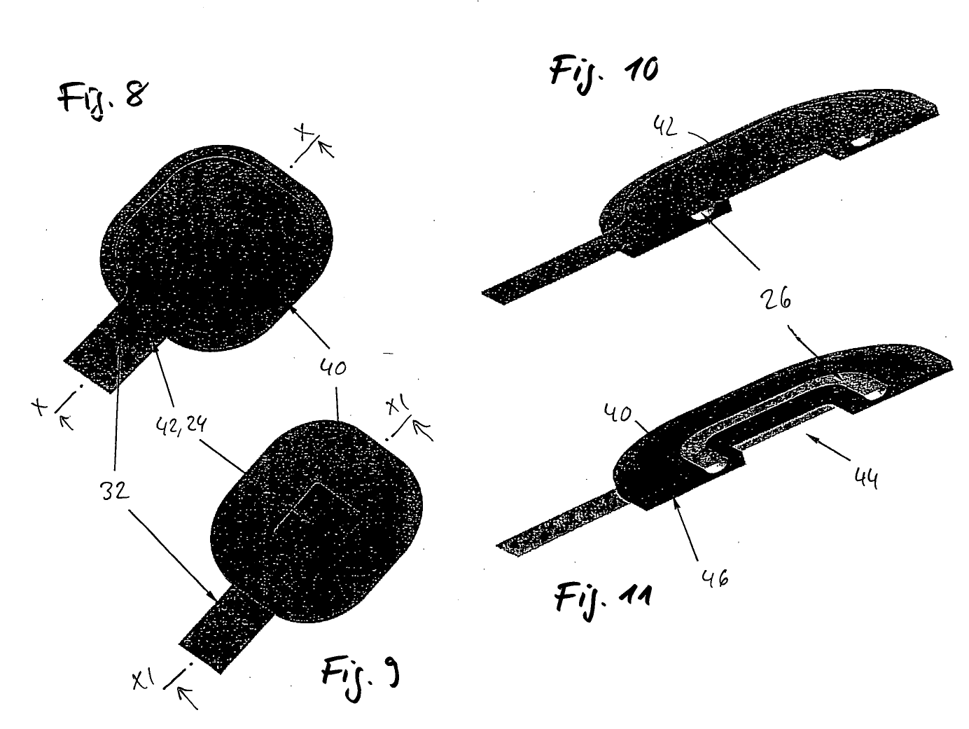

In FIGS. 8 to 11 a further example of the discharge arrangement 18 is illustrated. The discharge arrangement 18 comprises a housing, made of plastic, for example, having bottom and top parts 40 and 42, respectively. The top part 42 serves as mounting 24 for the unit able to be activated and includes the hinge region 32. The bottom part 40 has a central opening 44 corresponding to the discharge opening provided in case of activation. An electrolyte, applied as a layer, or a pyrotechnic charge 26 is arranged around the central opening 44 and represents the unit able to be activated. The unit able to be activated is located between the bottom part 40 and the top part 42, which are connected to each other by ultrasonic welding, for example. The housing of the discharge arrangement 18 having the unit able to be activated is attached to the gas generator carrier of the gas bag module or to the air bag fabric by glueing, sewing or by a mechanical connection (pressing or the like), at least at the site designated as 46. The discharge arrangement 18 according to FIGS. 8 to 11 has the advantage that it is a prefabricated unit that can be installed universally.

1. A gas bag module for a vehicle occupant restraint system, the gas bag module including a gas bag and a discharge arrangement, the discharge arrangement having a unit able to be activated by a control arrangement for selectively providing a discharge opening, the unit able to be activated being arranged on a mounting which performs a hinge function upon activation of the unit.

2. The gas bag module according to claim 1, wherein the mounting has a plastic or metal plate.

3. The gas bag module according to claim 1, wherein the mounting has a hinge region and a swivel section on which the unit able to be activated is fastened.

4. The gas bag module according to claim 1, wherein the discharge arrangement is arranged on a rigid component of the gas bag module.

5. The gas bag module according to any of claim 1, wherein the discharge arrangement is arranged on a wall of the gas bag.

6. The gas bag module according to claim 5, wherein that particular regions of the gas bag fabric adjoining the discharge arrangement are weakened.

7. The gas bag module according to claim 6, wherein the weakened regions are coordinated with the unit able to be activated such that upon activation of the unit the gas bag fabric tears open in the weakened regions.

8. The gas bag module according to claim 3, wherein the particular regions of the gas bag fabric adjoining the discharge arrangement are weakened, the weakened regions being only provided on one side of the hinge region.

9. The gas bag module according to claim 6, wherein the weakened regions being formed by outlet openings.

10. The gas bag module according to claim 9, wherein the outlet openings are constructed such that the effective cross-section of the outlet openings increases as the internal pressure of the gas bag increases.

11. The gas bag module according to claim 1, wherein electric leads connect the discharge arrangement with the control arrangement, the electric leads being integrated into the gas bag fabric.

12. The gas bag module according to claim 1, wherein the unit able to be activated is a pyrotechnic unit.

13. The gas bag module according to claim 1, wherein the unit able to be activated has an electrorheological fluid.

14. The gas bag module according to claim 1, wherein the unit able to be activated has an electrolyte.

15. The gas bag module according to claim 1, wherein the discharge arrangement comprises a prefabricated unit.
